(19) United States
(12) Patent Application Publication
(10) Pub. No.: US 2012/0166174 A1
(43) Pub. Date: Jun. 28, 2012

(54) CONTEXT SENSITIVE LANGUAGE ASSISTANT

(75) Inventor: Natalia D. Lipetskaia, Jersey City, NJ (US)

(73) Assignee: General Electric Company, Schenectady, NY (US)

(21) Appl. No.: 12/976,692

(22) Filed: Dec. 22, 2010

(51) Int. Cl. G06F 17/28

(52) U.S. Cl. 704/3

(57) ABSTRACT

An example user interface translator includes an interface analysis subsystem to analyze a selected portion of a graphical interface and to capture a topological representation of the selected portion. The selected portion of the graphical interface has a first textual context including a first language used to depict the selected portion of the graphical interface. The translator includes a matching subsystem to match the captured topological representation of the selected portion with a stored reference topological representation. The reference topological representation is to be associated with a second textual context including a second language. The translator includes a translation subsystem to translate the first textual context of the selected portion of the graphical interface to the second textual context of the reference topological representation. The translator includes a delivery subsystem to provide a translation of the selected portion of the graphical interface in conjunction with the graphical interface.

### FIELD

The present invention generally relates to user interface translation. In particular, the present invention relates to systems, methods, and apparatus for selection and translation of an area of a user interface during execution of an application that provides the user interface.

### BACKGROUND

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, equipment and computerized information systems. Personnel in a healthcare facility must manage a plurality of patients, systems, and tasks to provide quality service to patients. Healthcare personnel may encounter many difficulties or obstacles in their workflow. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow.

Different clinical departments and different clinical systems gather patient information in different ways and in different forms and often separately store that information. Additionally, clinical systems and associated clinical information may span many countries and include many languages.

### BRIEF SUMMARY

Certain examples provide systems, methods, and apparatus to provide context-sensitive language translation for user interfaces.

Certain examples provide a context-sensitive language translation system. The system includes an interface navigator to allow a user to select a portion of a graphical interface by manipulating the interface navigator. The selected portion of the graphical interface has a first textual context including a first language used to depict the selected portion of the graphical interface. The system includes a scanner to capture a topological representation of the selected portion of the graphical interface. The system includes a mapper to match the captured topological representation of the selected portion with a stored reference topological representation. The reference topological representation is to be associated with a second textual context including a second language. The system includes a translator to translate the first textual context of the selected portion of the graphical interface to the second textual context of the reference topological representation. The system includes an output to provide a translation of the selected portion of the graphical interface in conjunction with the graphical interface.

Certain examples provide a tangible computer readable storage medium including executable program instructions which, when executed by a computer processor, cause the computer to implement a user interface translator. The translator includes an interface analysis subsystem to analyze a selected portion of a graphical interface and to capture a topological representation of the selected portion. The selected portion of the graphical interface has a first textual context including a first language used to depict the selected portion of the graphical interface. The translator includes a matching subsystem to match the captured topological representation of the selected portion with a stored reference topological representation. The reference topological representation is to be associated with a second textual context including a second language. The translator includes a translation subsystem to translate the first textual context of the selected portion of the graphical interface to the second textual context of the reference topological representation. The translator includes a delivery subsystem to provide a translation of the selected portion of the graphical interface in conjunction with the graphical interface.

Certain examples provide a computer-implemented method for user interface translation. The method includes accepting a user selection of a portion of a graphical user interface. The method includes deriving a topological representation from the selected portion of the graphical interface, the topological representation associated with a textual context including a first language. The method includes mapping the topological representation to a prospective topological representation associated with a textual context including a second language. The method includes translating the selected portion of the graphical user interface from the first language to the second language based on the mapping between the topological representation and the prospective topological representation for each user interface component in the selected portion. The method includes displaying the translated portion of the graphical user interface in conjunction with the graphical user interface for access by the user.

### BRIEF DESCRIPTION OF SEVERAL VIEWS OF THE DRAWINGS

FIG. 1 illustrates an example interface analysis and translation system.

FIG. 2 illustrates an example interface analysis and translation system.

FIG. 3 illustrates an example interface translation.

FIG. 4 depicts a flow diagram for an example method for user interface translation.

FIG. 5 depicts a flow diagram for an example method for user selection and translation of a graphical user interface.

FIG. 6 shows a block diagram of an example clinical information system.

FIG. 7 is a block diagram of an example processor system that may be used to implement systems, apparatus, and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, Blu-ray, etc., storing the software and/or firmware.

Certain examples provide run-time, context sensitive translation of selected areas of a localized user interface without knowledge of or intervention with the underlying application's source code and/or development process. Certain examples provide a tool to scan an application interface's screen topology, recognize a selected area, map the selected area to a stored master topology, extract one or more text properties of the selection in a master language, translate the text property(ies) of the selected area from the master language to a chosen language (e.g., a language selected and/or defined by the user), and deliver and present the translation on the localized screen as part of the application user interface.

Production, testing, and support of multiple localized versions of a global application requires non-proportional efforts due to a necessity of testing and remote support/help by a person who is not proficient with the local language. Application serviceability depends on online collaboration and context sharing between client services, help desk, and application users. Certain examples provide systems and methods to facilitate collaboration between parties having context sensitive, instant and accurate translation a selected area in a localized user interface.

Certain examples help to resolve a bottleneck of complications stemming from collaborating with localized user interfaces for testing, technical support, help desk, and knowledge sharing. Certain examples provide online, context sensitive and accurate translation when needed.

Some representative but not exclusive examples include a multi-user field engineering/client services workstation collaboration, help topic localization including images and diagrams using a help desk workstation, improvement in speed and quality of testing of localized user interfaces via a quality assurance testing workstation, bilingual usage for online translation of sensitive data into a language of choice, etc.

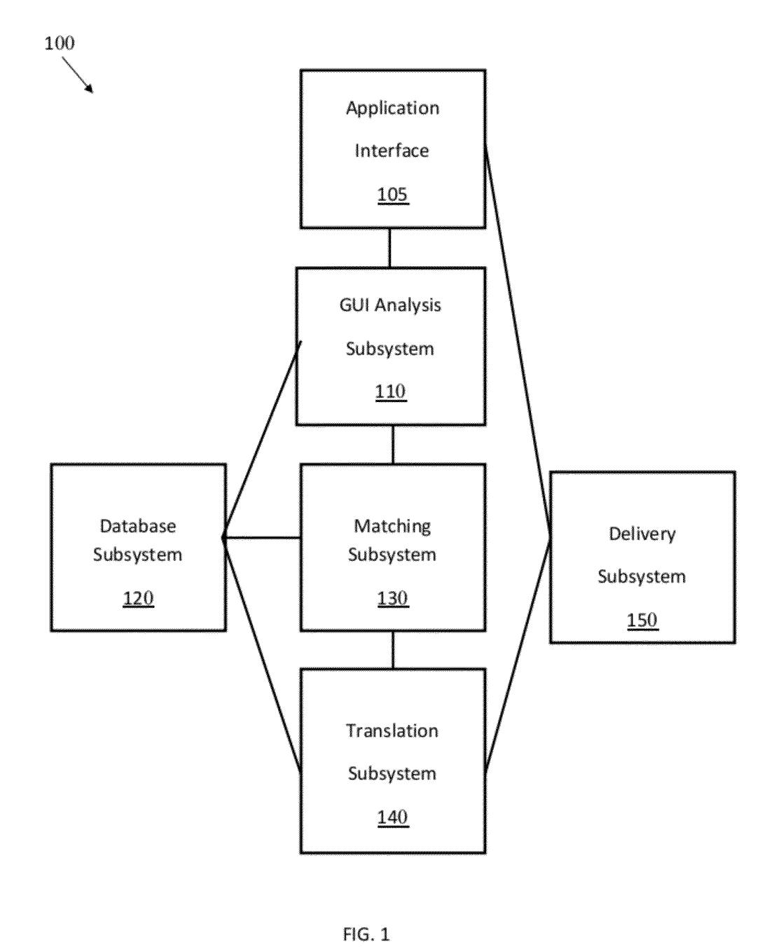

FIG. 1 illustrates an example interface analysis and translation system 100 including a graphical user interface (GUI) analysis subsystem 110, a database subsystem 120, a matching subsystem 130, a translation subsystem 140, and a delivery subsystem 150. The GUI analysis subsystem 110 can retrieve a screen topological representation from an application interface 105 independent from a display screen's resolution and presentation scheme. The database subsystem 120 supports a library of elementary building blocks for user interfaces including building blocks for adding and generating thumbnails for new GUI element(s). Additionally, the database subsystem 120 includes a multilayer storage including storage of a screen's images; layouts, positions and textual properties of the elementary building blocks, for example. The matching subsystem 130 can be used to match stored and scanned screen topology, for example. The translation subsystem 140 can translate a textual context of a selected GUI area. The delivery subsystem 150 can present a translated selection of an interface 105 for display on a screen. In certain examples, the translation subsystem 140 and delivery subsystem 150 can provide translations of multiple selected portions of the graphical interface in conjunction with the graphical interface. In certain examples, results of previous translation(s) may co-exist and/or be replaced by results of the current translation(s).

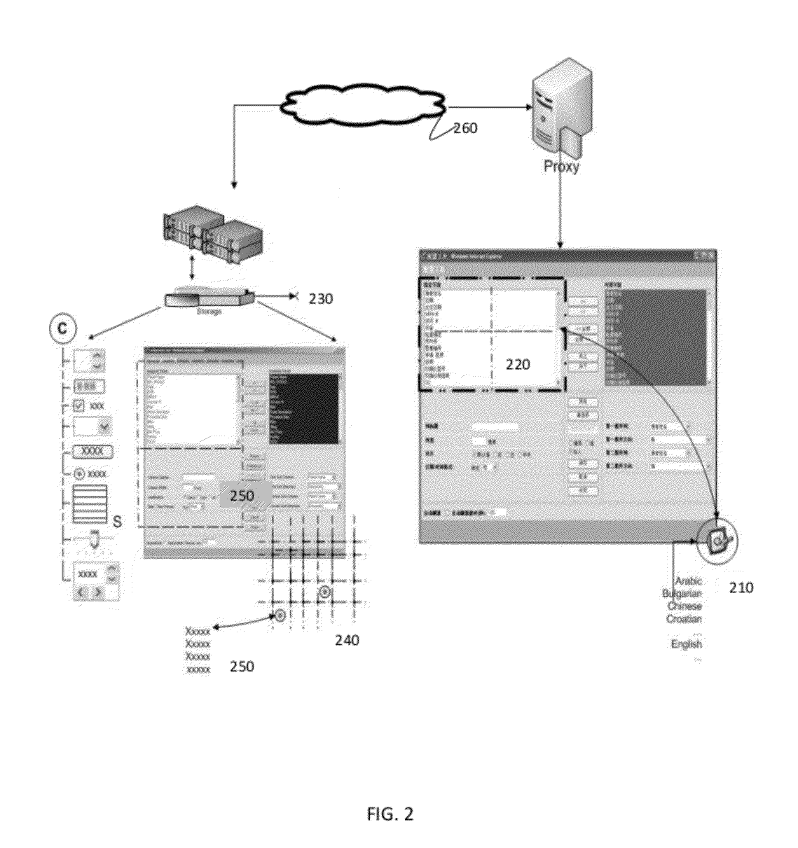

FIG. 2 illustrates an example interface analysis and translation system 200 including a navigator 210, a scanner 220, a storage medium 230, a mapping mechanism 240, a translation 250, and a delivery mechanism 260. The navigator 210 (e.g., a sprite-like navigator) allows a user to navigate a displayed user interface and select an area of the user interface. The scanner 220 is to scan the area of the user interface selected by the navigator 210. The scanner 220 elicits the user interface screen's topological representation (and related features) from the selected area. The topological representation can be structured and parsed (e.g., into topological nodes) and stored in the storage medium 230. Text from the selected area of the user interface is represented in a master and/or reference language, for example.

The mapping mechanism 240 facilitates mapping of user interface content (e.g., text, icons, etc.) between stored and scanned topological nodes. The mapping mechanism 240 includes a translation 250 of a text property value of a topological node from the master language to a requested language. The requested language can be specified by a user, a system setting, a default, a user context, a patient context, etc. The delivery mechanism 260 provides translated nodes to be displayed on the screen with the user interface. The translated nodes form a translation of the selected user interface area into the requested language that is displayed as part of the user interface for user review and interaction.

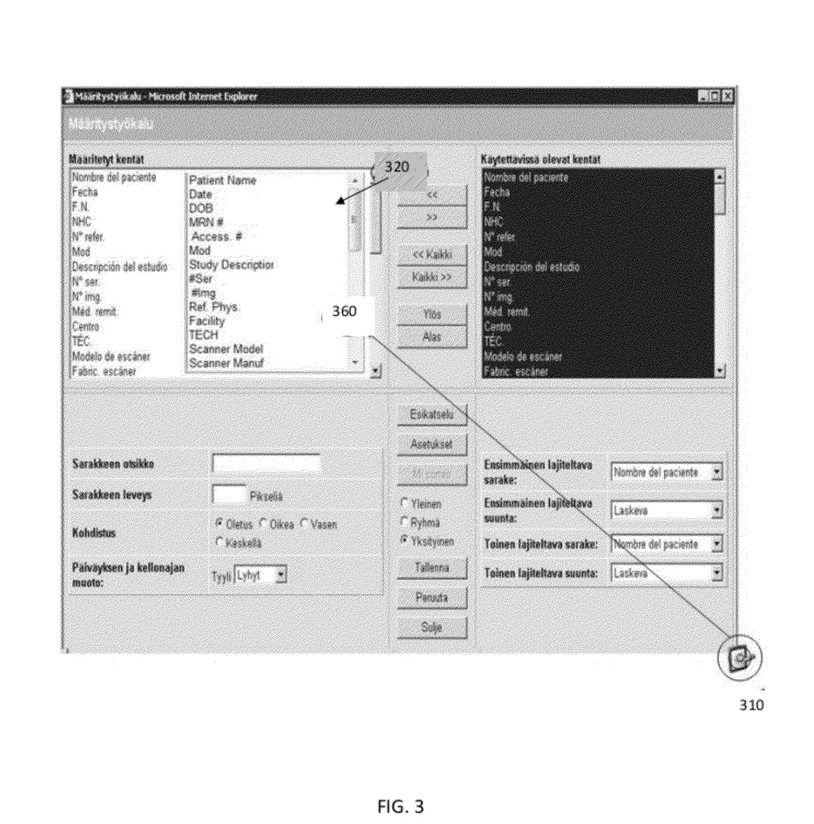

FIG. 3 illustrates an example interface translation 300 including a navigator 310, a scanner 320, and a translated rendering 330. As shown in the example of FIG. 3, the navigator 310 (e.g., a sprite-like navigator) facilitates user navigation and selection of an area of a displayed user interface. The navigator 310 provides an ability for the user to choose a language of translation for a selected area in an application's user interface. For example, the navigator 310 allows the user to select a portion of the graphical interface by manipulating the navigator 310 and to choose a language of translation via a text input field, checkbox, dropdown list, etc. The navigator 310 can be used to select a portion of the interface along with system and/or user configuration settings, for example. The scanner 320 scans and elicits the displayed interface's topological features/representation. The translated rendering 330 is shown, based on node translations, as part of the application user interface screen. In certain examples, more than one translation of a selected area can delivered into application's interface, and the translations can co-exist either in side-by-side or overlapping mode. Results of previous translation(s) may co-exist and/or be replaced by results of current translation(s), for example.

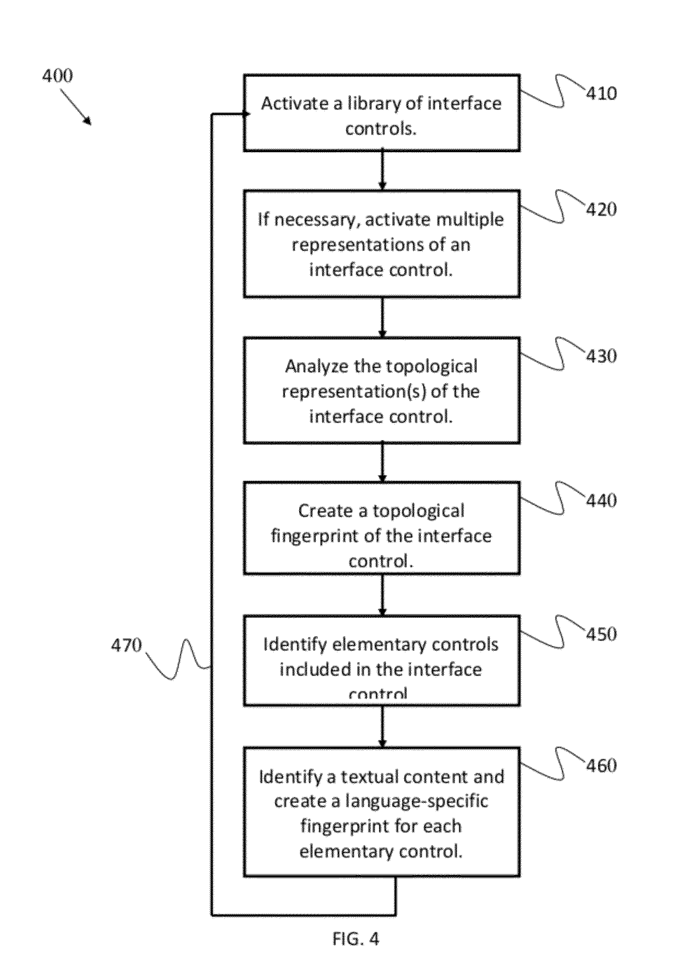

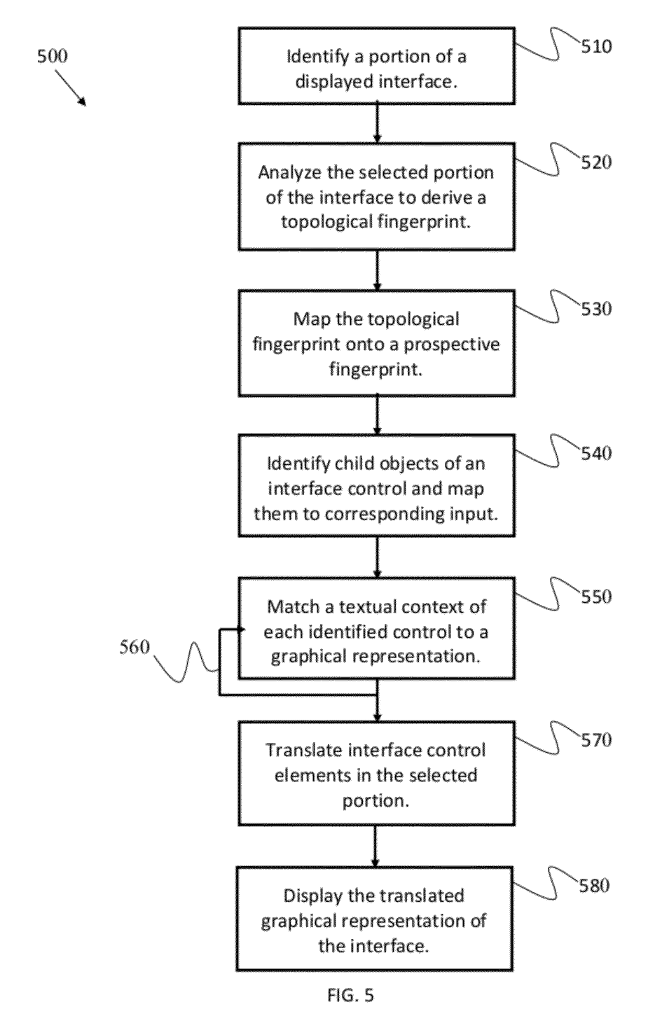

FIGS. 4-5 represents a flow diagram representative of example machine readable instructions that can be executed to implement the example systems shown in FIGS. 1-3 and/or portions of one or more of those and/or other systems. The example process(es) of FIGS. 4-5 can be performed using a processor, a controller and/or any other suitable processing device. For example, the example process(es) of FIGS. 4-5 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIGS. 4-5 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIGS. 4-5 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIGS. 4-5 can be implemented manually or as any combination(s) of any of the foregoing techniques, for example, any combination of firmware, software, discrete logic and/or hardware. Further, although the example process(es) of FIGS. 4-5 are described with reference to the flow diagram of FIGS. 4-5, other methods of implementing the process(es) of FIGS. 4-5 can be employed. For example, the order of execution of the blocks can be changed, and/or some of the blocks described can be changed, eliminated, sub-divided, or combined. Additionally, any or all of the example process(es) of FIGS. 4-5 can be performed sequentially and/or in parallel by, for example, separate processing threads, processors, devices, discrete logic, circuits, etc.

FIG. 4 depicts a flow diagram for an example method 400 for user interface translation. As shown in the example of FIG. 4, a localized software application in the process of its execution is first subjected to a scan of a topological representation of its user interface(s) (e.g., screens). At block 410, an operator activates a library of UI controls including, but not limited to, standard controls such as text boxes, dialog boxes, toolbars, menus, combo boxes, drop down lists, data grids, etc., and custom controls. The operator can add a new standard/custom control to the library using, for example, the GUI analysis subsystem 110 of FIG. 1.

At block 420, if not all context elements are visible at once, then multiple topological representations of the same GUI control are activated, manipulated and saved in tight relation with each other so that the multiplicity of representations is included in the full content of the textual context available in the GUI control. For example, some items of the selection list may be hidden beyond a portion of the list that is visible to a user via the interface.

At block 430, the topological representation obtained at 410, 420 is analyzed. For example, the topological representation is provided as an input to the GUI Analysis subsystem 110 directly and/or via a file or file collection save in any applicable graphic file format.

At block 440, a topological fingerprint of the GUI control is created. For example, the GUI Analysis Subsystem 110 creates the topological fingerprint for the selected GUI control and the control's associated composition to allow for unambiguous identification of the GUI control composition and elementary controls from a variety of its graphical representations including but not limited to: different screen resolution, different color scheme, different style (e.g., NT/XT/Vista/MAC/other), etc. If possible, the fingerprint may allow for confident identification of GUI composition, even if only part of its topological representation is available for analysis, for example. The fingerprint is added to the control library as a separate entry with a unique identifier, for example.

At block 450, elementary GUI controls used with the GUI control composition are identified. For example, the GUI analysis subsystem 110 identifies elementary GUI controls used within the composition (including but not limited to: radio-button groups, check-box groups, combo-boxes, list boxes, captions, free text, etc). Each identified control is added to the control library under a unique identifier, for example.

At block 460, for each of the identified elementary controls, a textual content is identified and a language-specific fingerprint is created. For example, for each of the identified elementary controls, the GUI analysis subsystem 110 identifies its respective textual content and creates a language specific fingerprint, which can have multiple representations most suitable for any particularly use case, such as but not limited to: ASCII code representation, Bitmap representation, vector graphics representation, etc. Certain controls (including but not limited to selection lists, combo-boxes, etc.) can have multiple instances of their representations further related as a textual representation array. In certain examples, full content of textual representation arrays can be identified even if full recovery of the arrays involves analysis of multiple screenshots of a GUI control and/or control's composition; each screenshot visualizes a part of the array.

At block 470, blocks 410 to 460 are repeated for multiple representations of the same GUI controls and/or control compositions configured for a different language from the supported language set. Textual fingerprints related to the same GUI control can be combined into a multi-lingual string with respect to all supported languages, for example. The string is stored in a comprehensive database with relation to the record of its parent GUI control, for example.

FIG. 5 depicts a flow diagram for an example method 500 for user selection and translation of a graphical user interface. At block 510, a user identifies a rectangular or other area of a localized user interface (e.g., displayed screen) presented to the user as part of an application workflow. For example, the selected area is substantially representative for unambiguous identification of a “topological fingerprint” of an individual GUI control or control composition stored in a comprehensive database (e.g., the database subsystem 120 and/or storage medium 230). The topological fingerprint includes, for example, interface components, arrangement, configuration, etc.

At block 520, the user defined/selected graphical area of the GUI is analyzed to derive a topological fingerprint from the selected GUI area. For example, the user-selected area of the GUI is input into the GUI analysis subsystem 110 for derivation of its topological fingerprint. At block 530, the topological fingerprint is mapped onto prospective fingerprint. For example, the topological fingerprint derived from the GUI area by the GUI analysis subsystem 110 is mapped onto a prospective fingerprint stored in a comprehensive or GUI translation database (e.g., (e.g., the database subsystem 120 and/or storage medium 230).

At block 540, child objects associated with the composition of a selected GUI control are identified and mapped onto a corresponding input. For example, according to a database record associated with the prospective fingerprint, child objects, also referred to as elementary controls, for each GUI control in the fingerprint are identified and mapped onto user graphical input. At block 550, a textual context of each identified GUI control is matched to a graphical representation on the GUI. For example, according to a corresponding fingerprint and/or record in the database for each individual GUI control identified at block 540, the control's textual context is matched to its graphical representation on the selected user input graphical area via the matching subsystem 130. At block 560, block 550 is repeated for each elementary GUI control identified in the selected user-input graphical area.

At block 570, based on user preference and/or selection of a destination or translation language, all identified control elements in the selected area are substituted with their corresponding control elements presented in the destination language. For example, based on user choice of a destination language, all identified elements of controls in the selected area that are currently presented in a displayed language are substituted with respective elements presented in the destination language via the translation subsystem 140. At block 580, a graphical representation of the textual context from the displayed language substituted by the same context in the destination language is displayed for user reference and visual perception on a display. Thus, for example, the translated user interface area is displayed to the user via the GUI (e.g., via the delivery subsystem 150).

Thus, certain examples systems, methods, and apparatus provide a context sensitive language assistant to compare stored user interface elements to selected ones in a GUI for an executing application. Topological characteristics of selected area of the GUI are extracted and compared to topology stored in persistent storage. Topologies stored in persistent storage and real-time scanned topologies have no notion of language. Rather, topologies involve image recognition rather than language characteristics.

Certain examples distinguish between the same or similar user interface elements having different textual content. A screen topology scanner captures a layout in which a user interface element lives including an upper level form, section, frame, etc., including a hierarchy of layouts into which the user interface element is nested. A textual property of the scanned layout is translated. The textual property can be represented as an array, for example. The array can include as many rows as translations to different languages exist for a textual property. An index to select a language of choice is provided by a client side navigator (e.g., a sprite-like visual representation of a context sensitive language assistant).

Certain examples provide a service with a visual representation that is dragged and dropped by a user onto a GUI of an executing client application. The client application can be of any origin (e.g., browser and/or form based, etc.), as the service is independent of application origin and allows a user to select an area of interest within the client application's GUI, extract its topology, and transmit the topology along with a language of chosen translation to a processor. The processor invokes a mapping mechanism to map between stored and scanned topology, and finds matching topological nodes with textual properties in a language of choice. The matching topology is transmitted back to the service. The service renders a popup, overlay, and/or user interface modification, for example, that visualizes the selected area with translated textual context. In certain examples, both original and translated GUI areas can be visible side by side, the translated area may overlay the original selection, etc.

In certain examples, when a match between stored and scanned topology is not found or a match is found but a language of choice is not presented in the textual property array, then there may be no dynamic recognition for the scanned topology. In certain examples, human intervention and/or a more detailed modeling and analysis can be facilitated to add a new topology pattern into storage for use in mapping and translation.

In certain examples, an automatic optical inspection process is applied to identify and topology of features in a selected user interface area. An image of the selected area is captured and analyzed by a template matching of standard geometrical elements to the captured image of the original interface pattern presented through its graphical file. The pattern is translated into a serialized list of standard template(s) with associated geometrical arrangement(s) and connectivity scheme(s).

In certain examples, a matching algorithm processes a real-time image of a portion of a user interface including a subset of all elements of a design template. In certain examples, the actual image is matched to a corresponding design template. In certain examples, rather than a one to one match, a one to many matching can occur.

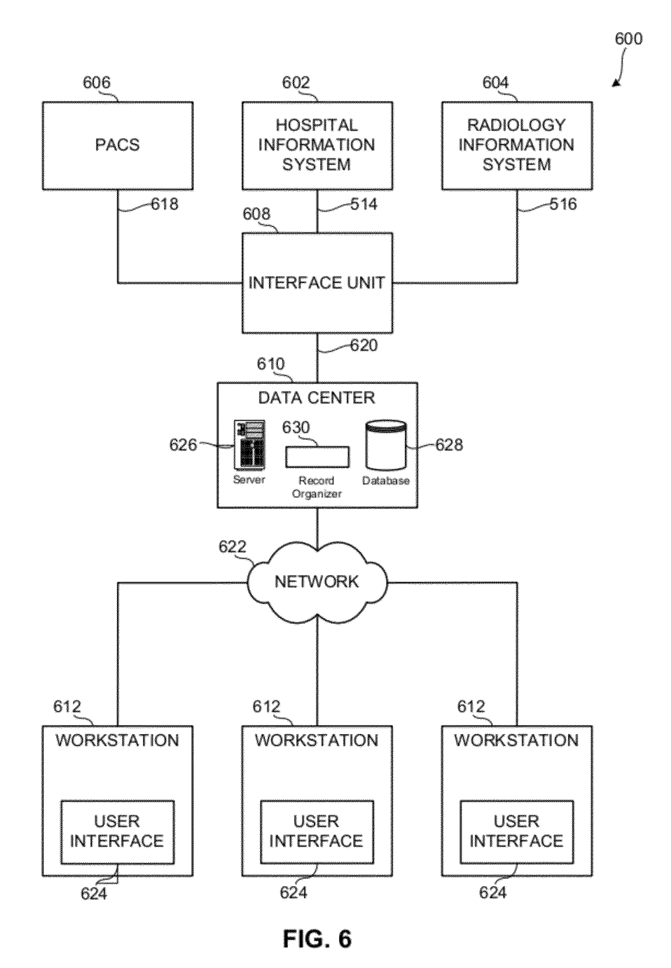

FIG. 6 shows a block diagram of an example clinical information system 600 capable of implementing the example methods and systems described herein. The example clinical information system 600 includes a hospital information system (HIS) 602, a radiology information system (RIS) 604, a picture archiving and communication system (PACS) 606, an interface unit 608, a data center 610, and a plurality of workstations 612. The system 600 can alternatively or in addition include one more of a computerized physician order entry (CPOE), an electronic medical record (EMR), a clinical information system (CIS), a cardiovascular information system (CVIS), a library information system (LIS), and/or other healthcare information system, for example.

In the illustrated example, the HIS 602, the RIS 604, and the PACS 606 are housed in a healthcare facility and locally archived. However, in other implementations, the HIS 602, the RIS 604, and/or the PACS 606 can be housed one or more other suitable locations. In certain implementations, one or more of the PACS 606, RIS 604, HIS 602, etc., can be implemented remotely via a thin client and/or downloadable software solution. Furthermore, one or more components of the clinical information system 600 can be combined and/or implemented together. For example, the RIS 604 and/or the PACS 606 can be integrated with the HIS 602; the PACS 606 can be integrated with the RIS 604; and/or the three example information systems 602, 604, and/or 606 can be integrated together. In other example implementations, the clinical information system 600 includes a subset of the illustrated information systems 602, 604, and/or 606. For example, the clinical information system 600 can include only one or two of the HIS 602, the RIS 604, and/or the PACS 606. Information (e.g., scheduling, test results, observations, diagnosis, etc.) can be entered into the HIS 602, the RIS 604, and/or the PACS 606 by healthcare practitioners (e.g., radiologists, physicians, and/or technicians) before and/or after patient examination.

The HIS 602 stores medical information such as clinical reports, patient information, and/or administrative information received from, for example, personnel at a hospital, clinic, and/or a physician's office. The RIS 604 stores information such as, for example, radiology reports, messages, warnings, alerts, patient scheduling information, patient demographic data, patient tracking information, and/or physician and patient status monitors. Additionally, the RIS 604 enables exam order entry (e.g., ordering an x-ray of a patient) and image and film tracking (e.g., tracking identities of one or more people that have checked out a film). In some examples, information in the RIS 604 is formatted according to the HL-7 (Health Level Seven) clinical communication protocol.

The PACS 606 stores medical images (e.g., x-rays, scans, three-dimensional renderings, etc.) as, for example, digital images in a database or registry. In some examples, the medical images are stored in the PACS 606 using the Digital Imaging and Communications in Medicine (“DICOM”) format. Images are stored in the PACS 306 by healthcare practitioners (e.g., imaging technicians, physicians, radiologists) after a medical imaging of a patient and/or are automatically transmitted from medical imaging devices to the PACS 606 for storage. In some examples, the PACS 606 can also include a display device and/or viewing workstation to enable a healthcare practitioner to communicate with the PACS 606.

The interface unit 608 includes a hospital information system interface connection 614, a radiology information system interface connection 616, a PACS interface connection 618, and a data center interface connection 620. The interface unit 608 facilities communication among the HIS 602, the RIS 604, the PACS 606, and/or the data center 610. The interface connections 614, 616, 618, and 620 can be implemented by, for example, a Wide Area Network (“WAN”) such as a private network or the Internet. Accordingly, the interface unit 608 includes one or more communication components such as, for example, an Ethernet device, an asynchronous transfer mode (“ATM”) device, an 802.11 device, a DSL modem, a cable modem, a cellular modem, etc. In turn, the data center 610 communicates with the plurality of workstations 612, via a network 622, implemented at a plurality of locations (e.g., a hospital, clinic, doctor's office, other medical office, or terminal, etc.). The network 622 is implemented by, for example, the Internet, an intranet, a private network, a wired or wireless Local Area Network, and/or a wired or wireless Wide Area Network. In some examples, the interface unit 608 also includes a broker (e.g., a Mitra Imaging's PACS Broker) to allow medical information and medical images to be transmitted together and stored together.

In operation, the interface unit 608 receives images, medical reports, administrative information, and/or other clinical information from the information systems 602, 604, 606 via the interface connections 614, 616, 618. If necessary (e.g., when different formats of the received information are incompatible), the interface unit 608 translates or reformats (e.g., into Structured Query Language (“SQL”) or standard text) the medical information, such as medical reports, to be properly stored at the data center 610. The reformatted medical information can be transmitted using a transmission protocol to enable different medical information to share common identification elements, such as a patient name or social security number. Next, the interface unit 608 transmits the medical information to the data center 610 via the data center interface connection 620. Finally, medical information is stored in the data center 610 in, for example, the DICOM format, which enables medical images and corresponding medical information to be transmitted and stored together.

The medical information is later viewable and easily retrievable at one or more of the workstations 612 (e.g., by their common identification element, such as a patient name or record number). The workstations 612 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 612 receive commands and/or other input from a user via, for example, a keyboard, mouse, track ball, microphone, etc. As shown in FIG. 6, the workstations 612 are connected to the network 622 and, thus, can communicate with each other, the data center 610, and/or any other device coupled to the network 622. The workstations 612 are capable of implementing a user interface 624 to enable a healthcare practitioner to interact with the clinical information system 600. For example, in response to a request from a physician, the user interface 624 presents a patient medical history. Additionally, the user interface 624 includes one or more options related to the example methods and apparatus described herein to organize such a medical history using classification and severity parameters. Alternatively or additionally, the user interface 624 and/or other information/capability from the workstation 612 can be provided via a mobile and/or other handheld device, for example.

The example data center 610 of FIG. 6 is an archive to store information such as, for example, images, data, medical reports, and/or, more generally, patient medical records. In addition, the data center 610 can also serve as a central conduit to information located at other sources such as, for example, local archives, hospital information systems/radiology information systems (e.g., the HIS 602 and/or the RIS 604), or medical imaging/storage systems (e.g., the PACS 606 and/or connected imaging modalities). That is, the data center 610 can store links or indicators (e.g., identification numbers, patient names, or record numbers) to information. In the illustrated example, the data center 610 is managed by an application server provider (“ASP”) and is located in a centralized location that can be accessed by a plurality of systems and facilities (e.g., hospitals, clinics, doctor's offices, other medical offices, and/or terminals). In some examples, the data center 610 can be spatially distant from the HIS 602, the RIS 604, and/or the PACS 606 (e.g., at General Electric® headquarters).

The example data center 610 of FIG. 6 includes a server 626, a database 628, and a record organizer 630. The server 626 receives, processes, and conveys information to and from the components of the clinical information system 600. The database 628 stores the medical information described herein and provides access thereto. The example record organizer 630 of FIG. 6 manages patient medical histories, for example. The record organizer 630 can also assist in procedure scheduling, for example.

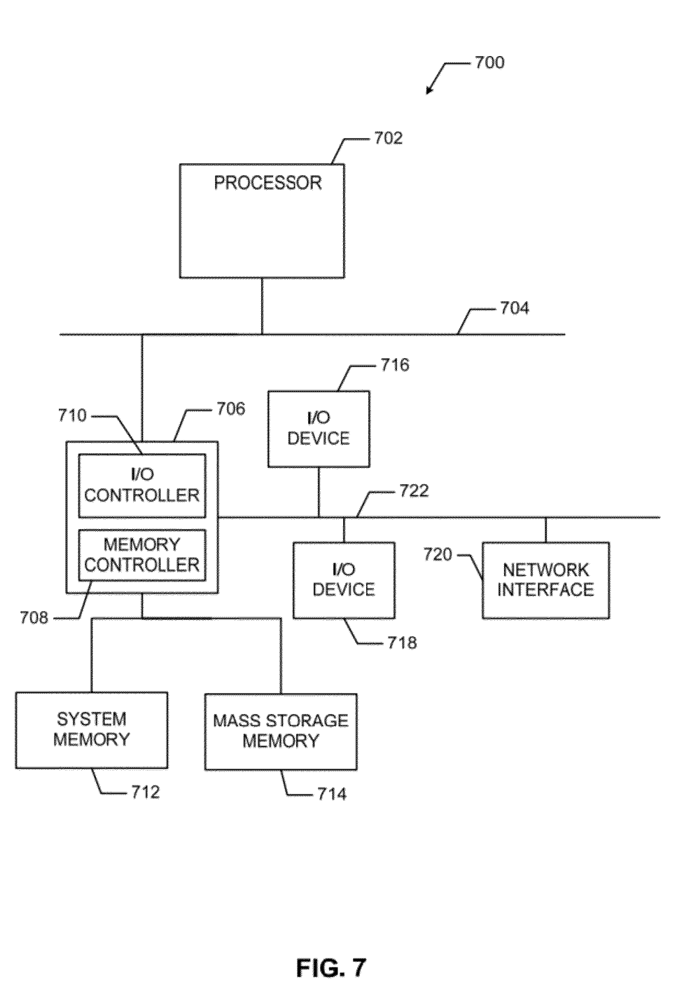

FIG. 7 is a block diagram of an example processor system 710 that can be used to implement systems, apparatus, and methods described herein. As shown in FIG. 7, the processor system 710 includes a processor 712 that is coupled to an interconnection bus 714. The processor 712 can be any suitable processor, processing unit, or microprocessor, for example. Although not shown in FIG. 7, the system 710 can be a multi-processor system and, thus, can include one or more additional processors that are identical or similar to the processor 712 and that are communicatively coupled to the interconnection bus 714. For example, “cloud” and/or “grid” based computing can be employed for three dimensional processing using Euclidian vectors and linear algebra, as described above. In certain examples, a Bayesian algorithm can be used in an evolving model combining multiple executions of multiple algorithms. As certain mappings are resolved, a probability associated with other remaining mappings changes.

The processor 712 of FIG. 7 is coupled to a chipset 718, which includes a memory controller 720 and an input/output (“I/O”) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 can include any desired type of volatile and/or non-volatile memory such as, for example, static random access memory (SRAM), dynamic random access memory (DRAM), flash memory, read-only memory (ROM), etc. The mass storage memory 725 can include any desired type of mass storage device including hard disk drives, optical drives, tape storage devices, etc.

The I/O controller 722 performs functions that enable the processor 712 to communicate with peripheral input/output (“I/O”) devices 726 and 728 and a network interface 730 via an I/O bus 732. The I/O devices 726 and 728 can be any desired type of I/O device such as, for example, a keyboard, a video display or monitor, a mouse, etc. The network interface 730 can be, for example, an Ethernet device, an asynchronous transfer mode (“ATM”) device, an 802.11 device, a DSL modem, a cable modem, a cellular modem, etc., that enables the processor system 710 to communicate with another processor system.

While the memory controller 720 and the I/O controller 722 are depicted in FIG. 7 as separate blocks within the chipset 718, the functions performed by these blocks can be integrated within a single semiconductor circuit or can be implemented using two or more separate integrated circuits.

Certain embodiments contemplate methods, systems and computer program products on any machine-readable media to implement functionality described above. Certain embodiments can be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a machine accessible or readable medium and executable by, for example, a processor system (e.g., the example processor system 710 of FIG. 7). When any of the appended claims are read to cover a purely software and/or firmware implementation, at least one of the components is hereby expressly defined to include a tangible medium such as a memory, DVD, CD, Blu-ray disc, etc. storing the software and/or firmware.

Certain embodiments contemplate methods, systems and computer program products on any machine-readable media to implement functionality described above. Certain embodiments can be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media can be any available media that can be accessed by a general purpose or special purpose computer or other machine with a processor. By way of example, such computer-readable media can include RAM, ROM, PROM, EPROM, EEPROM, Flash, CD-ROM, DVD, Blu-ray or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions include, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention can be practiced in a networked environment using logical connections to one or more remote computers having processors. Logical connections can include a local area network (LAN) and a wide area network (WAN) that are presented here by way of example and not limitation. Such networking environments are commonplace in office-wide or enterprise-wide computer networks, intranets and the Internet and can use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention can also be practiced in distributed computing environments where tasks are performed by local and remote processing devices that are linked (either by hardwired links, wireless links, or by a combination of hardwired or wireless links) through a communications network. In a distributed computing environment, program modules can be located in both local and remote memory storage devices.

While the invention has been described with reference to certain embodiments, it will be understood by those skilled in the art that various changes can be made and equivalents can be substituted without departing from the scope of the invention. In addition, many modifications can be made to adapt a particular situation or material to the teachings of the invention without departing from its scope. Therefore, it is intended that the invention not be limited to the particular embodiment disclosed, but that the invention will include all embodiments falling within the scope of the appended claims.

1. A context-sensitive language translation system comprising:
an interface navigator to allow a user to select a portion of a graphical interface by manipulating the interface navigator, the selected portion of the graphical interface having a first textual context including a first language used to depict the selected portion of the graphical interface;
a scanner to capture a topological representation of the selected portion of the graphical interface;
a mapper to match the captured topological representation of the selected portion with a stored reference topological representation, the reference topological representation associated with a second textual context including a second language;
a translator to translate the first textual context of the selected portion of the graphical interface to the second textual context of the reference topological representation; and
an output to provide a translation of the selected portion of the graphical interface in conjunction with the graphical interface.

2. The system of claim 1, wherein the reference topological representation is to be stored according to a master language and associated with the second language based on a desired language user request.

3. The system of claim 1, wherein the translation of the selected portion of the graphical interface replaces the selected portion of the graphical interface.

4. The system of claim 1, wherein the translation of the selected portion of the graphical interface is provided as a pop-up window in conjunction with the graphical interface.

5. The system of claim 1, wherein the translation of the selected portion of the graphical interface is displayed along with the selected portion of the graphical interface.

6. The system of claim 1, further comprising a database to include a library of elementary controls associated with the reference topological representation for matching and translation.

7. The system of claim 1, wherein the scanner is to be associated with a graphical user interface analysis subsystem.

8. The system of claim 1, wherein translation is to be facilitated during execution of an application associated with the graphical interface.

9. The system of claim 1, wherein the topological representation includes one or more of a drop-down list, a data grid, a caption, free text, and a custom control.

10. The system of claim 1, wherein the mapper is to select among a plurality of reference topological representations corresponding to the captured topological representation.

11. A tangible computer readable storage medium including executable program instructions which, when executed by a computer processor, cause the computer to implement a user interface translator comprising:
an interface analysis subsystem to analyze a selected portion of a graphical interface and to capture a topological representation of the selected portion, the selected portion of the graphical interface having a first textual context including a first language used to depict the selected portion of the graphical interface;
a matching subsystem to match the captured topological representation of the selected portion with a stored reference topological representation, the reference topological representation associated with a second textual context including a second language;
a translation subsystem to translate the first textual context of the selected portion of the graphical interface to the second textual context of the reference topological representation; and
a delivery subsystem to provide a translation of the selected portion of the graphical interface in conjunction with the graphical interface.

12. The computer readable storage medium of claim 11, wherein the reference topological representation is to be stored according to a master language and associated with the second language based on a desired language user request.

13. The computer readable storage medium of claim 11, wherein the translation of the selected portion of the graphical interface replaces the selected portion of the graphical interface.

14. The computer readable storage medium of claim 11, wherein the translation of the selected portion of the graphical interface is displayed along with the selected portion of the graphical interface.

15. The computer readable storage medium of claim 11, further comprising a database to include a library of elementary controls associated with the reference topological representation for matching and translation.

16. The computer readable storage medium of claim 11, wherein translation is to be facilitated during execution of an application associated with the graphical interface.

17. A computer-implemented method for user interface translation comprising:
accepting a user selection of a portion of a graphical user interface;
deriving a topological representation from the selected portion of the graphical interface, the topological representation associated with a textual context including a first language;
mapping the topological representation to a prospective topological representation associated with a textual context including a second language;
translating the selected portion of the graphical user interface from the first language to the second language based on the mapping between the topological representation and the prospective topological representation for each user interface component in the selected portion; and
displaying the translated portion of the graphical user interface in conjunction with the graphical user interface for access by the user.

18. The method of claim 17, wherein displaying comprises displaying the translated portion of the graphical interface in place of the selected portion of the graphical interface.

19. The method of claim 17, wherein displaying comprises displaying the translated portion of the graphical interface is displayed along with the selected portion of the graphical interface.

20. The method of claim 17, wherein translation is to be facilitated during execution of an application associated with the graphical interface.
